(19) United States
(12) Patent Application Publication
(10) Pub. No.: US 2012/0180241 A1
(43) Pub. Date: Jul. 19, 2012

(54) Round trowel

(76) Inventor: James Ward Gibeau, Custer, SD (US)

(21) Appl. No.: 12/930,709

(22) Filed: Jan. 13, 2011

(51) Int. Cl. B05C 17/10

(52) U.S. Cl. 15/235.4

(57) ABSTRACT

A round trowel is disclosed which may be used to shape or work materials such as concrete, stucco, or plaster, where there is an interior corner which is concave.

### BACKGROUND OF THE INVENTION

1. Field of the Invention

The present invention relates generally to construction tools and more specifically to a round trowel which may be used to work concave surfaces.

2. Background Information

For hundreds of years people have been using materials such as concrete, stucco, and plaster in the construction of various objects including buildings. Most often such materials are a mixture of various materials which are nearly inert until water is added. Once water has been added, the material may be added to a structure and shaped, molded, or otherwise “worked” until a good portion of the added water has evaporated or otherwise left the material. When the material is sufficiently dry, it becomes hard and relatively weatherproof. At this point it is usually no longer possible to shape, mold, or work the material. Often such materials are placed over another material such as wire mesh to aid in insuring that the material will stick or adhere to the rest of the structure.

Shaping, molding, or working such materials is often done to provide a necessary or pleasing surface texture. For example, concrete is often worked with a flat trowel in order to provide a smooth surface. Quite often stucco or plaster is applied in a thick, rough layer and only the outer surface is smoothed to provide a pleasing dappled appearance.

Conventional trowels have been used for many years to shape or work materials such as concrete, stucco, or plaster. A conventional trowel most often has a flat, rectangular metal plate which forms the working surface and a handle is attached to make the trowel easy to use. Such flat, conventional trowels work very well when the material to be worked is flat or has a convex surface. However, the flat surface of the conventional trowel makes is much less effective when the surface to be worked is concave. For example, stucco covered buildings often have a horizontal overhang which connects to and project outward from a vertical wall. In such instances, the wall and the overhang meet to form a right triangle. Most often this right triangle is rounded off such that there is a concave surface between the overhand and the wall. Conventional trowels don't work very well to shape such areas, because the surface is round and concave and the trowel is flat. It will be understood that there are many other instances where materials such as concrete, stucco, or plaster are formed into similar shapes.

The round trowel of the instant invention solves the above related problem with conventional trowels. Rather than having a flat working surface, the round trowel of the instant invention has a round working surface which fits within and works much more effectively than a conventional flat trowel. The ideal round trowel of the instant invention should provide a simple and efficient method of shaping or working materials such as concrete, stucco, or plaster when they are formed into a concave shape. The ideal invention should also be simple, reliable, inexpensive, and easy to operate and maintain.

### SUMMARY OF THE INVENTION

The round trowel of the instant invention is similar to a conventional trowel in that is has a working surface and a handle. However, rather than having a flat working surface, the round trowel of the instant invention has a rounded working surface. The working surface is convex such that it easily fits within a concave portion of concrete, stucco, or plaster.

One of the major objects of the present invention is to provide a simple and efficient method of shaping or working materials such as concrete, stucco, or plaster when they are formed into a concave shape.

Another objective of the present invention is to provide a round trowel which is simple, reliable, inexpensive, and easy to use and maintain.

These and other features of the invention will become apparent when taken in consideration with the following detailed description and the drawings.

### BRIEF DESCRIPTION OF THE DRAWINGS

FIG. 1 is a side view of the round trowel of the instant invention;

FIG. 2 is a sectional view of the round trowel of the instant invention taken along line 1-1 of FIG. 1;

FIG. 3 shows an end view of the round trowel of the instant invention in use to shape a concave surface; and

FIG. 4 shows an end view of a conventional trowel in used to shape a concave surface.

### DESCRIPTION OF A PREFERRED EMBODIMENT

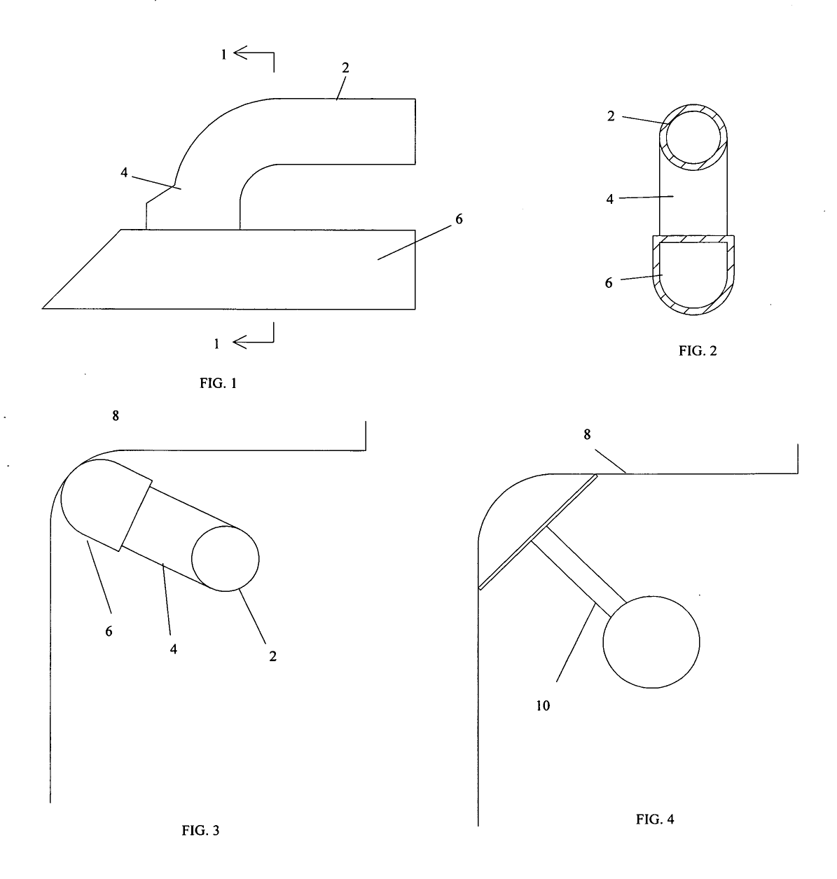

Referring to the drawings, FIGS. 1 and 2, there are shown various views of the round trowel of the instant invention. FIG. 3 shows an end view of the instant invention is use. FIG. 4 shows a conventional trowel being used for the same purpose as the round trowel in FIG. 3.

Now referring to FIG. 1, a side view of the round trowel of the instant invention is shown. A handle 2 is provided which performs the same function as the handle of a conventional trowel in that it allows a user to easily hold and manipulate the tool. The handle 2 has the general shape of a hollow cylinder, but any shape which provides for a comfortable grip could be used. A tang 4 is affixed to said handle 2 and protrudes from said handle 2 at what is generally a right angle. A blade 6 is affixed to the tang 4 such that it is generally parallel to said handle 2. The surface of the blade 6 furthest from said handle 2 has a generally round shape. The end of said handle 2 not affixed to said tang 4 is considered to be the rearward end of the round trowel of the instant invention. The forward end of said blade 6 is angled rearward and upward such that the surface of said blade 6 furthest from said handle 2 is longer than the surface of said blade 6 closest to said handle 2.

Referring now to FIG. 2 a sectional view of the instant invention taken along line 1-1 of FIG. 1 is shown. This view better shows the cylindrical shape of said handle 2 and that said handle 2 is hollow to reduce the weight of the round trowel of the instant invention. This view also shows that said blade 6 has the general, cross sectional, shape of a “D” with the flat portion of the “D” toward said handle 2. This flat portion provides for a secure connection to said tang 4. However, the round trowel of the instant invention would work well regardless of the shape of said blade 6 provided that the portion of the surface of said blade 6 furthest from said handle 2 is round.

Referring now to FIG. 3, an end view of the round trowel of the instant invention in use shown. Surface 8 represents any of a number of occurrences where a surface covered with concrete, stucco, plaster, or similar material has a concave shape in at least one corner. As may be seen, said blade 6 fits easily within such a corner and, because of the round shape of said blade 6, such interior, concave corners are also easily worked using the instant invention. The end of said blade 6 which comes to an angled point (see FIG. 1) allows the tool to be more easily used in close quarters. For example, if said surface 8 formed a three sided corner rather than the two sided corner as shown, it would be easier to work with the round trowel of the instant invention with the pointed end than it would be if the end were flat.

Referring now to FIG. 4, an end view of a flat bladed, conventional trowel 10 in use is shown. Note that the shape of the flat blade of the conventional trowel 10 does not conform to the shape of the inner corner nearly as well as the round trowel of the instant invention. It would appear to be obvious that it would be much easier to work this interior corner of the surface 8 with the round trowel of the instant invention than with said conventional trowel 10.

All of the elements of the round trowel of the instant invention are made of plastic in the preferred embodiment. The trowel could easily made using injection molding. However, the round trowel of the instant invention could also be made with said blade 6 and said tang 4 being made from steel and said handle 2 made from wood. That is, any of the elements of the instant invention could be made from plastic, metal, or any other material having similar characteristics of strength, resilience, and chemical resistance.

While preferred embodiments of this invention have been shown and described above, it will be apparent to those skilled in the art that various modifications may be made in these embodiments without departing from the spirit of the present invention. That is, the device could be used for a wide variety of purposes either in combination or separately.

I claim:

1. A round trowel for use with stucco, concrete or similar materials comprising:
(1) a handle having a forward end and a rearward end; and
(2) a blade being affixed to the handle; the blade being roughly parallel to said handle;
and said blade being round on the portion of the surface of said blade away from said handle.

2. The round trowel of claim 1 in which the forward portion of said blade is angled rearward and toward said handle.

3. A round trowel for use with stucco, concrete or similar materials comprising;
(1) a handle having a forward end and a rearward end; and
(2) a blade being affixed to the handle and said blade having a generally cylindrical shape with the longitudinal axis of said blade being roughly parallel with said handle.

4. The round trowel of claim 3 in which the forward portion of said blade is angled rearward and toward said handle.

5. A round trowel for use with stucco, concrete or similar materials comprising:
(1) a handle having a forward end and a rearward end; and
(2) a blade being affixed to the handle and the blade having a hollow, slender shape in which the longitudinal axis of said blade is roughly parallel to said handle; and the portion of said blade surface furthest from said handle being round.

6. The round trowel of claim 5 in which the forward portion of said blade is angled rearward and toward said handle.
